(19) United States
(12) Patent Application Publication
(10) Pub. No.: US 2025/0118147 A1
(43) Pub. Date: Apr. 10, 2025

(54) HYBRID GAMEPLAY WITH CARD STATION AND DEALER ASSISTANCE

(71) Applicant: Interblock d.o.o., Menges (SI)

(72) Inventors: John Joseph Connelly, Las Vegas, NV (US); Jeffrey Kowalchuk, Las Vegas, NV (US)

(21) Appl. No.: 18/896,375

(22) Filed: Sep. 25, 2024

Related U.S. Application Data
(60) Provisional application No. 63/588,139, filed on Oct. 5, 2023.

(51) Int. Cl. G07F 17/32; A63F 1/06; A63F 1/14

(52) U.S. Cl. CPC G07F 17/322; A63F 1/067; A63F 1/14

(57) ABSTRACT

The present disclosure relates to live, hybrid card gaming systems, methods, and computing devices. Embodiments include a card gaming table having a playing surface defining at least one gaming area, at least one camera capturing a live feed of the at least one gaming area, a dealer console with an interactive user interface to enable a dealer to manage aspects of gaming events at the card table, and a gaming interface provided at a player display, such as a player display on a local or remote player station. Card gaming events include physical cards drawn in real-time at the card gaming table and reflected on the player display. Bets for the card gaming events may be received, in real-time, during a betting window defined at the dealer console.

### CROSS REFERENCE TO RELATED APPLICATIONS

This application claims benefit under 35 U.S.C. § 119(e) of Provisional U.S. Patent Application No. 63/588,139, filed Oct. 5, 2023, the contents of which is incorporated herein by reference in its entirety.

### TECHNICAL FIELD

The present disclosure relates generally, but not exclusively, to the field of gaming, particularly electronic table games.

### BACKGROUND INFORMATION

Casinos offer a variety of games to attract players. Such games may include live table games (e.g., card, craps, blackjack, etc.), virtual games, physical machines (e.g., slot-like machines and electronic table games), individual player machines, and various gameplay combinations.

Traditional card games often require a highly skilled dealer to manage tables and gaming events. A dealer must supervise and manage bets from one or more players, shuffle and deal multiple hands of cards, quickly determine payouts, and address any disputes or technical issues that arise. As a result, for many card games, the player to dealer ratio is often 6:1 or less. In baccarat, for example, the player to dealer ratio is typically 6:1. In blackjack, the player to dealer ratio is typically 5:1 or 6:1.

The player to dealer ratio can be a limiting factor for card tables and gaming locations that have a high demand and multiple players waiting to play. A live dealer also comes with the potential for human error and payout mistakes, such as where a losing bet is accidentally paid out or more is paid on a winning bet than should have been paid. Casinos and gaming locations operating card tables and live table games must therefore innovate to attract and retain players, maintain profitability, and improve player experience.

### SUMMARY

An embodiment is directed to live card gaming systems, methods, and computer programs. Embodiments include a card table comprising a playing surface defining at least one gaming area, at least one camera capturing a live feed of the at least one gaming area, a dealer console provided at the card table, and a gaming interface provided at a player display. The dealer console includes an interactive user interface to enable a dealer to manage aspects of gaming events at the card table, wherein the dealer console opens a betting window for a first gaming event, and closes the betting window in response to at least one of: a selection at the interactive dealer interface and a time expiration of the betting window, and the gaming interface provides the live feed of the at least one gaming area, and the gaming interface is configured to, in response to a selection made at the gaming interface, place a bet for the first gaming event during the betting window set at the dealer console.

These and other features will be more clearly understood from the following detailed description taken in conjunction with the accompanying drawings and claims. This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a perspective view of a live card gaming table with two card gaming areas, in accordance with an embodiment.

FIG. 2 is a perspective view of a live card gaming table with one card gaming area, in accordance with an embodiment.

FIG. 3 is a dealer-side view of features of the live card gaming table of FIG. 1, in accordance with an embodiment.

FIG. 4 is a dealer-side view of features of the live card gaming table of FIG. 2, in accordance with an embodiment.

FIG. 5 is a view of a portion of the interior area of the live card gaming table, in accordance with an embodiment.

FIG. 6A is an example table layout for Blackjack, in accordance with an embodiment.

FIG. 6B is another example table layout for Blackjack, in accordance with an embodiment.

FIG. 6C is an example table layout for Baccarat, in accordance with an embodiment.

FIG. 6D is an example table layout for Dai Bacc, in accordance with an embodiment.

FIG. 7 is an example of a Blackjack graphical user interface for a player station, in accordance with an embodiment.

FIG. 8 are additional examples of Blackjack graphical user interfaces for a player station, in accordance with an embodiment.

FIG. 9 is another example of a Baccarat graphical user interface for a player station, in accordance with an embodiment.

FIG. 10 are additional examples of Baccarat graphical user interfaces for a player station, in accordance with an embodiment.

FIG. 11 is an example of a Dai Bacc graphical user interface for a player station, in accordance with an embodiment.

FIG. 12 is another example of a Dai Bacc graphical user interface for a player station, in accordance with an embodiment.

FIG. 13A is an example of a dealer interface, in accordance with an embodiment.

FIG. 13B is another example of a dealer interface, in accordance with an embodiment.

FIG. 14 is an example arrangement of a live card gaming table and player stations, in accordance with an embodiment.

FIG. 15 is an example arena arrangement of a live card gaming table and player stations, in accordance with an embodiment.

FIG. 16 is an illustration of an exemplary block diagram representing a general-purpose computer system in which aspects of the methods and systems disclosed herein or portions thereof may be incorporated.

### DETAILED DESCRIPTION OF EMBODIMENTS

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

Disclosed herein are methods, systems, and non-transitory computer readable storage media that provide a live electronic table game (ETG) for card games. The card table may include one or more gaming areas on which card games may be played.

On a table with dual gaming areas, multiple card games, such as alternating games, alternating hands, etc., may be played. For example, a first card game may be initiated on the first gaming area, and a betting window for the second card game may start. The second card game on the second gaming area will start after the first card game ends, and a new betting window may begin for a next game on the first gaming area. Examples of card games that may be played include Blackjack, Blackjack Xtreme, Baccarat, Double Baccarat, Punto Banco, Dai Bacc, and Double Dai Bacc.

The card gaming table and its gameplay interfaces enable dealer-assisted gameplay to enable a plurality of players to play locally or remotely. Players may play on a player station having a display and an interactive interface to place bets. Other remote gaming options, such as playing on a remote or mobile computing device, may be available as well. The compact shape and footprint of the card gaming table enable space-saving, efficient placement in a gaming location, such as a casino floor, a pit, a stadium, or a gaming arena. Embodiments may therefore maximize space utilization without compromising the gameplay experience.

Player stations may be positioned around the card gaming table in a position to see the card gaming table and one or more gaming events occurring on the table. A live video feed of the table, including card and dealer actions may be provided on the player display to allow a better view of the gaming events, and to let the players see that the gaming events and results on the interactive interface correspond to the live, physical gaming event at the card gaming table. In examples the player interface includes a Picture-in-Picture (PIP) live feed of each card gaming area.

The card gaming table further includes an interactive dealer console, which assists a dealer with managing aspects of gaming events, including betting windows, card dealing, results determinations, and multiple, alternating gaming events between the gaming areas. As a result, significantly more card gaming events can be played in a given time, with a significantly higher dealer-to-player ratio than traditional card games. In some embodiments, twice the number of games can be played in a same amount of time as at a traditional card table, and the dealer-to-player ratio may be 5:1, 10:1, 50:1, 100:1, 200:1, 230:1, or higher.

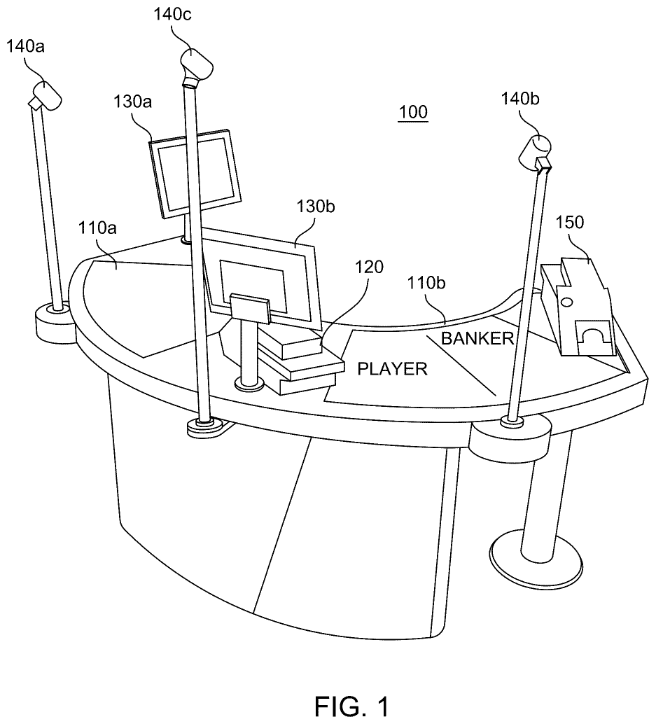

FIG. 1 illustrates example card gaming tables. FIG. 1 illustrates a first example including a curved card gaming table. The card gaming table may include at least one dealer display (e.g., displays 130a, 130b), a result generator, and a card shoe 150 which are mounted on top of a metal frame cabinet housing at least one computing device, electronics equipment, and control devices. The dealer display may provide information such as a number of active player stations, player information, or gaming information associated with individual player stations. The card gaming table may further include signage or other features to identify the game being played in the arena/stadium. Signage may also be helpful to attract players and provide other visual or audio effects, such as lighting, artwork, music, sound effects, etc.

As seen in FIG. 1, the card gaming table 100 includes a first gaming area 110a and a second gaming area 110b, which may be provided on a top portion of a gaming cabinet. In some examples, the gaming areas form the top portion of the gaming cabinet. A dealer console 120 connected to the one or more displays 130a, 130b enables a dealer to manage and operate aspects of card gaming events at the first gaming area 110a and the second gaming area 110b. For example, the dealer console may initiate a game (e.g., deal a hand) at the first gaming area 110a, and during the game at the first gaming area 110a, the dealer console opens a betting window for a second game at the second gaming area 110b. The betting window for the second game closes when the game at the first game ends. The end of the first game may occur, for example, when a last card is dealt, when a result is confirmed at the dealer console, or when bets are resolved.

At least one camera (e.g., cameras 140a, 140b, 140c) may capture a video feed of the first gaming area 110a and the second gaming area 110b, to be displayed on at least one display device (e.g., displays 130a, 130b, a display of a player device, etc.). A microphone may be provided to capture audio. The live feed may be a live video feed streamed to the display device to provide a live view of the card gaming area, cards on the table, and gaming events. The live feed may be provided as a PIP on a player display, and as a Picture-in-Display (PID) on one or more displays associated with the dealer console.

In some examples, the card gaming table 100 is a semi-circular table. A player side of the card gaming table may be longer than a dealer side of the card table. The player side may be larger to provide space for viewers, players, and/or player stations. The at least one camera 140a-c may be positioned above the card gaming areas. A first camera 140a may be positioned above the first gaming area 110a, and the second camera 140b may be positioned above the second gaming area 110b. The third camera 140c may provide a view of both gaming areas. The positions of one or more cameras may be adjustable. As seen in FIG. 1, a camera (e.g., camera 140a, 140, 140c) may be attached to an adjustable arm secured to the gaming table 100. The arm may be manipulated to adjust the camera view and may be removably attached to the gaming table 100.

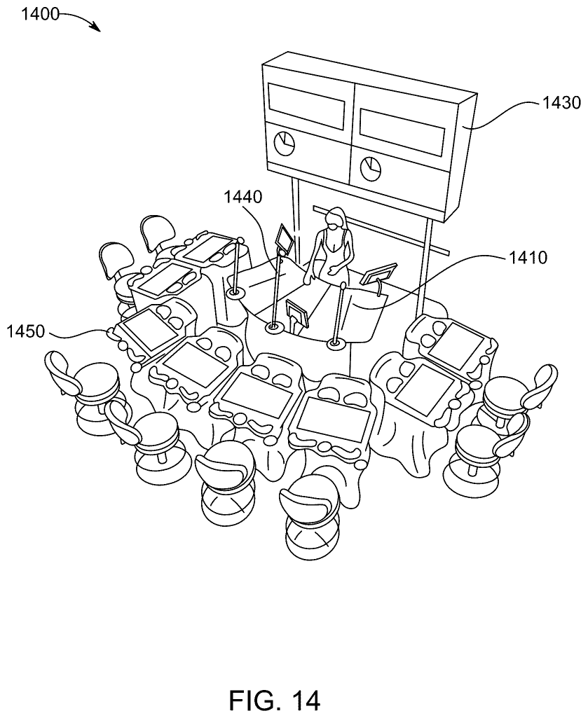

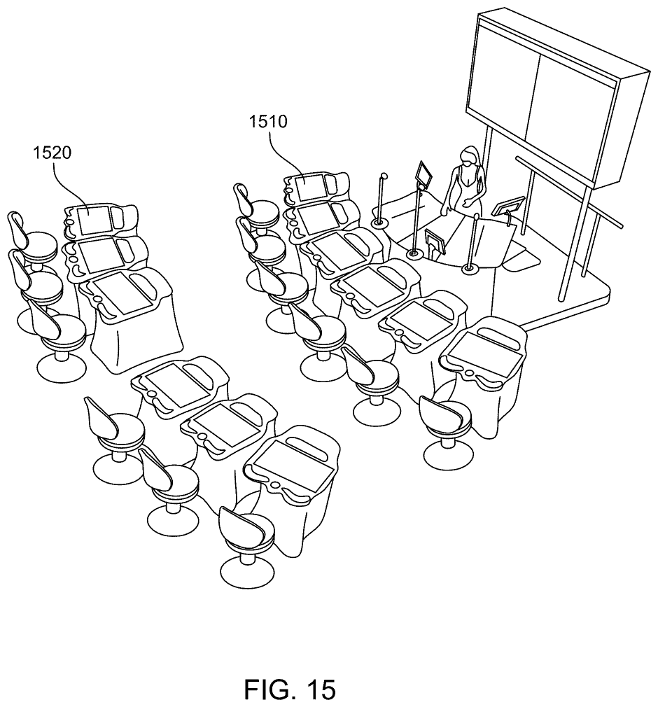

The dealer may stand on one side of the card gaming table so as to view the one or more displays (e.g., 130a, 130b), operate the dealer console 120 via the one or more displays, easily view the gaming areas, and execute card gaming events. In some examples, one or more player stations may be provided on an opposite side of the card gaming table (see, e.g., FIGS. 14-15). The card gaming table may be used in various gaming locations and environments, such as in casinos, in a stadium or arena environment, or as a standalone unit. In some examples, over 200 player stations can be connected to the card gaming table.

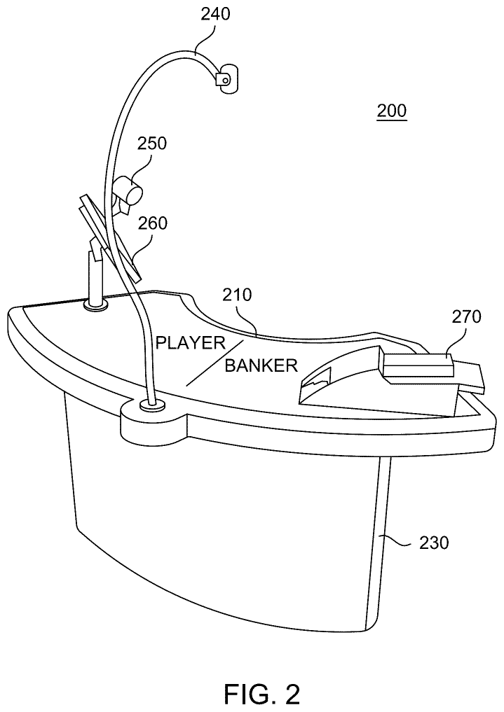

FIG. 2 illustrates similar features as the card gaming table of FIG. 1. The card gaming table of FIG. 2 may also be usable in a stadium or arena configuration, serving a plurality of player stations. As discussed herein (see, e.g., FIG. 15), the stadium or arena may be located within a gaming location, such as a casino, and be associated with a dedicated section having a perimeter defining the stadium or arena. A plurality of player stations may be arranged within the stadium or arena, facing the card gaming table.

The card gaming table 200 includes one card gaming area 210 provided on a top surface of a gaming cabinet 230. Similar to the card gaming table 100 of FIG. 1, the single-card game table may include a camera 240, a microphone 250, a display 260, and a card shoe 270. The display may provide at least one of a live video feed of the card gaming area as captured by the camera 240, and a dealer console interface to enable the dealer to manage and operate aspects of the gaming table 200 and any card gaming events.

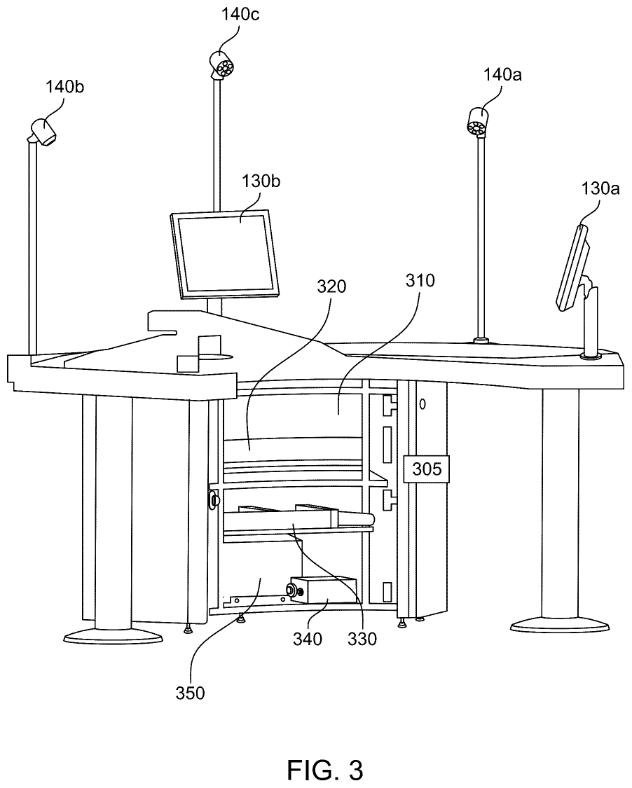

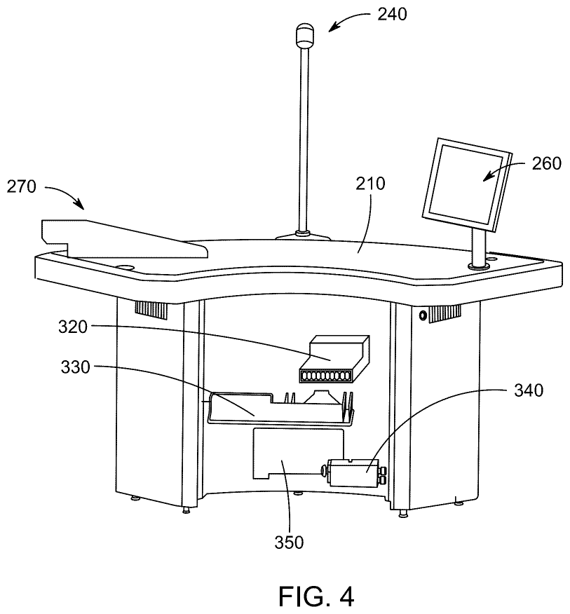

FIGS. 3-4 illustrate additional features of the card gaming tables 100, 200. At least one dealer display (e.g., displays 130a, 130b) may provide a dealer interface to enable a dealer to control aspects of card gaming events, including the first card gaming area 110a and a second card gaming 110b. A first display 130a may correspond to the first card gaming area 110a and the second display 130b may correspond to the second card gaming area 110b. In some examples, one or both displays may have a Radiofrequency Identification (RFID) reader to allow a dealer, supervisor, or other employee to log into the game. In some examples, at least one display is configured to display a tournament interface to allow the dealer to manage aspects of a Tournament game. Various interfaces, including live video feeds (e.g., PIDs), dealer interfaces, and the tournament display interface, may be interchanged between any of the displays at the card gaming table.

As noted above with respect to FIGS. 1-2, the card table may include at least one camera (e.g., cameras 140a, 140b) which can record a live feed of the card gaming areas. The live feed may be displayed, for example, on one or both of the dealer displays 130a, 130b, or on a display associated with a player station or player device. The live video feed may be provided as a Picture-in-Display (PID) or a Picture-in-Picture (PIP). In a PID, the live video feed may fill an entire display. In PIP, the live video feed may be provided within a portion of a display, such as on a gaming interface and/or overlaid on another image on the display.

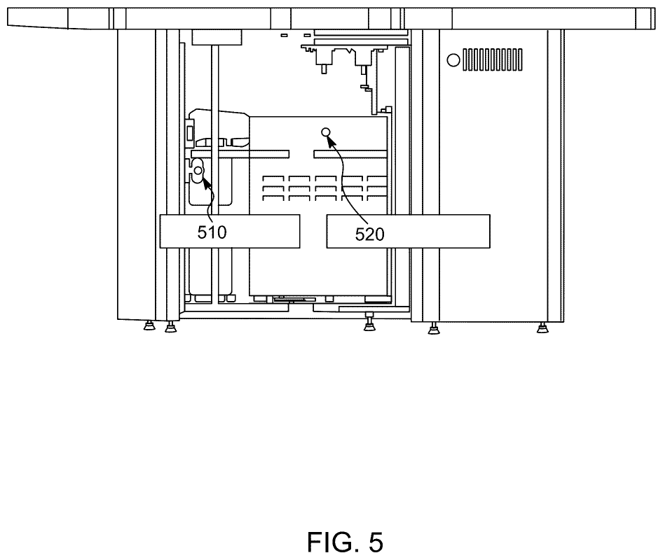

The card gaming table may include an interior portion, such as a hollow portion providing shelves and/or space for electronics and other items. The interior portion may be accessible via one or more doors 305 that enclose and protect components within the interior portion. As seen in FIG. 5, at least one door may include a door lock 510 to prevent unauthorized access to the interior portion. Other security features, such as an alarm, an RFID reader, or other sensors (e.g., tilt detection sensors, light sensors, etc.) may be added to protect contents within the gaming cabinet, restrict access, and reduce a risk of damage or theft of one or more components of the card gaming table.

The interior portion may include at least one controller for managing aspects of the gaming events, and gaming interfaces. A controller unit may include one or more switches and sensor units for operating any on-table cameras (e.g., cameras 140a, 140b). In some examples the controller unit 310 may include a switch for turning one or both cameras on and off. A sensor unit may, for example, determine one or more environmental conditions (e.g., lighting) to adjust an aspect of the cameras and the video feed. The controller unit 310 may include a PIP controller and a PID controller.

A gaming unit 320 may include at least one gaming controller to operate the card game. The gaming unit 320 may include software configured to at least provide and manage the dealer interface, player interface(s), dealt cards, a result determination, and a wager resolution. The gaming unit 320 may include multiple computing devices, such as a first computing device to operate and manage gaming aspects related to the first card game (e.g., identifying and/or tracking dealt cards) and a second computing device to operate and manage gaming aspects related to the second card game. An electronics box 330 may store one or more electronics components and computing devices within the cabinet.

A PIP controller may manage aspects of the one or more visual displays used with card gaming table. The PIP controller may include software configured to arrange one or more of images and videos on a player interface and the dealer interface(s). For example, the PIP controller may manage one or more aspects related to video size, position, and resolution on displays. A live video feed, for example, may be provided on a gaming interface, such as overlaid on a betting layout provided on a display on a player station. In some examples, the PIP controller may manage image and video display and placement related to one or more games, jackpots, and tournaments playable with the card gaming table. The PIP controller may be wired or wirelessly connected to other electronics components housed within the gaming cabinet. In some examples, the PIP controller is housed external to the gaming cabinet and communicates with one or more displays and player stations wirelessly.

A PID controller may similarly manage aspects of the one or more visual displays used with the card gaming table. A PID controller may provide a picture or video within a display. The PID controller may modify picture or video sizing, resolution, position, and other visual characteristics to fit on displays of various sizes. In an example, the PID controller include software to operate a Tournament game. The Tournament display may provide a unique interface for player devices, through which players may compete against each other during gaming events, such as one or more card gaming events. The PID controller may provide additional visual and/or interactive features to connected displays, such as alternate gaming events, advertisements, and information.

A power switch 340 may be provided within the interior portion to turn one or more electronics components on and off. In an example, a main power switch controls power to the displays, cameras, card shoes, controllers, and other electronics housed within the gaming cabinet. The power switch 340 may be associated with a power unit that may manage power to and from one or more components of the card gaming table. An uninterruptable power supply (UPS) may be provided to ensure operation in the event of a main power failure.

FIG. 5 illustrates example security features associated with the card gaming table. A door lock 510 may lock a door providing access to the interior portion of the gaming cabinet. The front door lock, as discussed herein, may be a physical lock (e.g., requiring a key), an electronic lock (e.g., requiring a scan of an identification card, a passcode entry, or other form of electronic authorization), a magnetic lock, or any other type of device to secure the interior portion and prevent unauthorized access. Similarly, an interior lock 520 may be provided to secure one or more components within the gaming cabinet, such as a computer or controller box. Additional security features may be implemented, as needed, on or within the gaming cabinet.

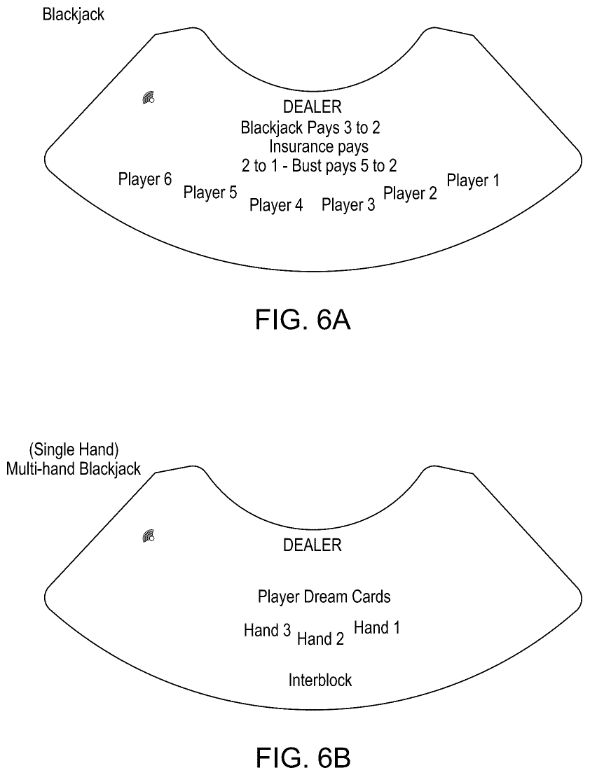

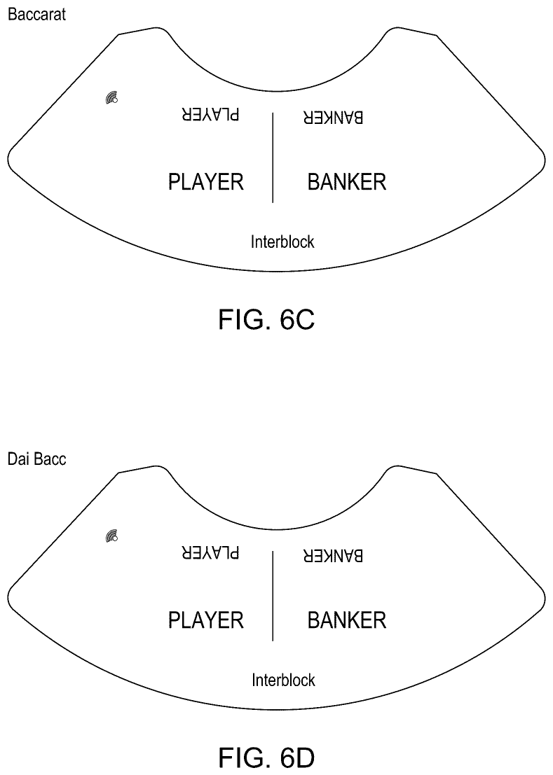

FIGS. 6A-6D illustrate different table layouts for the top surface of the gaming cabinet. The table layouts may be provided on a felt surface on the top of the gaming cabinet and match the respective card game to be played at the gaming cabinet. Table layout variations may come in any of a variety of colors, such as red, green, or yellow versions. FIG. 6A illustrates an example Blackjack or Blackjack Xtreme layout. In the example layout, up to 7 player areas may be provided on the surface, so that each player may have and play their own hand at the table. The design may also be changed to add more or less players areas.

FIG. 6B illustrates another example of a Blackjack gaming layout for games, such as single-hand, Blackjack, multi-hand Blackjack, single-hand, Blackjack Xtreme, or multi-hand Blackjack Xtreme. Instead of each player being dealt their own hand, each dealt hand can be individually wagered on by a plurality of players. In some examples, up to 233 players may play the game simultaneously, with each player having the same three hands. FIG. 6C illustrates a layout for baccarat and includes two player and banker areas. FIG. 6D illustrates an example Dai Bacc layout, which also includes two player and banker areas.

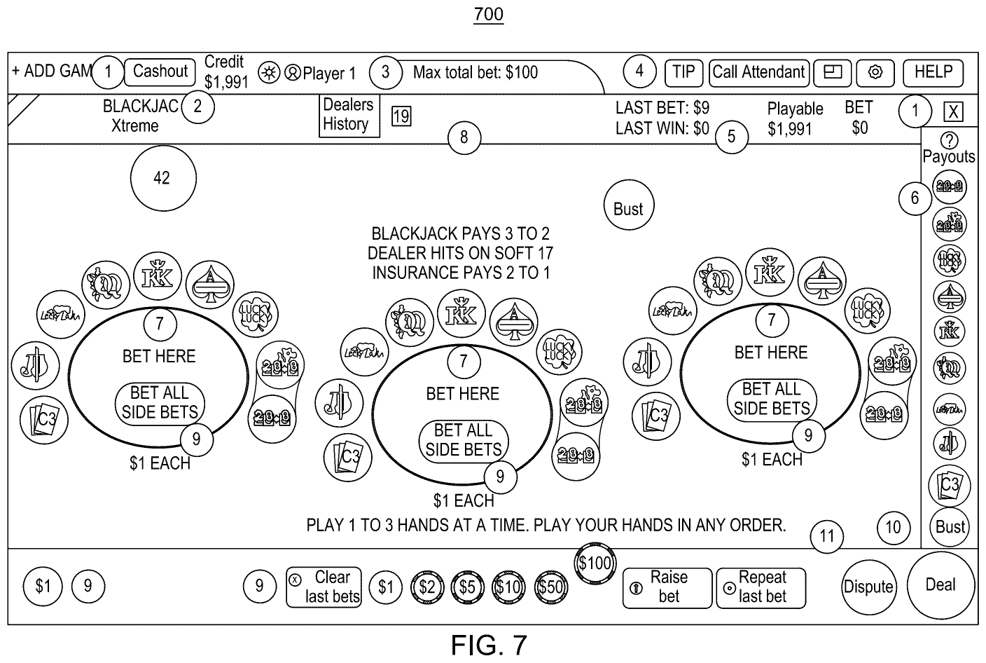

FIG. 7 illustrates an example player interface 700 for a blackjack game. The player interface has multiple betting areas to enable play on up to three separate hands. The player interface may be provided on a display associated with a player station or other player device, such as a mobile computing device, tablet, or laptop.

A top bar of the player interface may provide a summary regarding the card game and one or more quick-action selections. The top bar may indicate credits, including a “Credit” box indicating a total number of credits, e.g., related to a player account, and a “Playable” box indicating an amount of credits that the player can bet. A “Cash Out” button enables a player to cash out and receive any player credits via ticket printer, a credit add to a player account, or a cash payout from a dealer. The Cash Out selection may only be available when no bets are currently on the table. An add/close game button enables a player to add additional games and change the view of games.

Configurable selections may be provided to enable a player to customize a view of the player interface. For example, an opacity button may be provided to enable a player to reduce the visibility of the player's credits, last bet(s), and the playable amount. A “Main Information” display may provide gaming information, such as when a betting window opens, a time left in the betting window, and when a betting window closes. Error messages may also be provided. A “Call Attendant” or “Concierge” button may signal an attendant of the gaming device, an attendant on the casino floor, or another individual associated with the gaming location and assisting players. A “Tip” button allows sending a tip to the attendant. A “Flag” button may indicate a language used on the interface, and a selection of the button may enable a player to change the interface language. A “Speaker” button enables on/off control of speakers. An “Options” button may bring up a menu that includes additional information about the gameplay or the device. In some examples, the Options menu may include “Reserve Table” to allow a player to reserve a station for an amount of time, a “Show Bet Limits” to display all bet limits for different wagering options, and “Show Winnings,” which will display, as the user places bets, possible winnings for each bet. The possible winnings may be enabled or disabled using a slider or other toggle button. A “Help/Rules” option displays a help screen.

Betting information may be separately provided for each hand or card game. The betting information may indicate a Bet, Last Win, and Last Bet information. A Display Adjustment button allows a player to adjust their gaming layout left and right. One gaming layout may be enlarged while the other is decreased. A history bar on each betting layout will display the last pre-set number of wins corresponding to the respective gaming area.

A betting table provides respective betting layouts including betting fields arranged similarly to a live table. The betting table includes the betting options and combinations. Players may choose one or more selections to assign a bet.

A bet timer provides an indication of whether a betting window is open or closed and may provide a time left for a player to place a bet. A Statistics button may be provided on each betting layout to see respective gaming statistics for each card game. A “Side Bets” button displays information about side bets.

Statistics, such as Dealer Statistics and Player History may provide a number of the most frequent dealer outcomes (Blackjack, bust 21, 20, 19, 18, 17, etc.) in the last pre-set number of games, and a pre-set number of the player's previous results.

Controls enable Denomination, Chips and Game Controls for each respective layout. A Denomination control sets the value of one credit and hence the value of the game. The selected value of one credit may be displayed on the denomination button. The Chips control enables players to select and place chips of different values on the table. Values assigned to chips may be defined with the selected denomination. In some examples, if multi-denomination is disabled, only chips may be available. The Game Control selection may include features to Clear Last Bet, Clear All Bets, Double Bet, Repeat Last Bet, Game Chips, and Fast Bet (i.e., selecting multiple options by dragging a finger across desired fields). A “Copy Bets” button allows a player to copy all of their bets from one layout to the other layout. Bets may be copied manually or automatically. An arrow button, for example, may allow a player to easily copy bets from the left side to the right side or vice versa. If bets are already placed on one game, the “Copy Bets” button may only copy the highest valued bets.

A PIP display provides a live video feed of the card gaming table, in real-time. The live video feed may show all aspects of the gaming event in real-time, including but not limited to, a start of the gaming event, card flips, hands, and a gaming event result. The PIP display may be enlarged or minimized using an arrow button. The PIP display may also be moved and locked to a desired position.

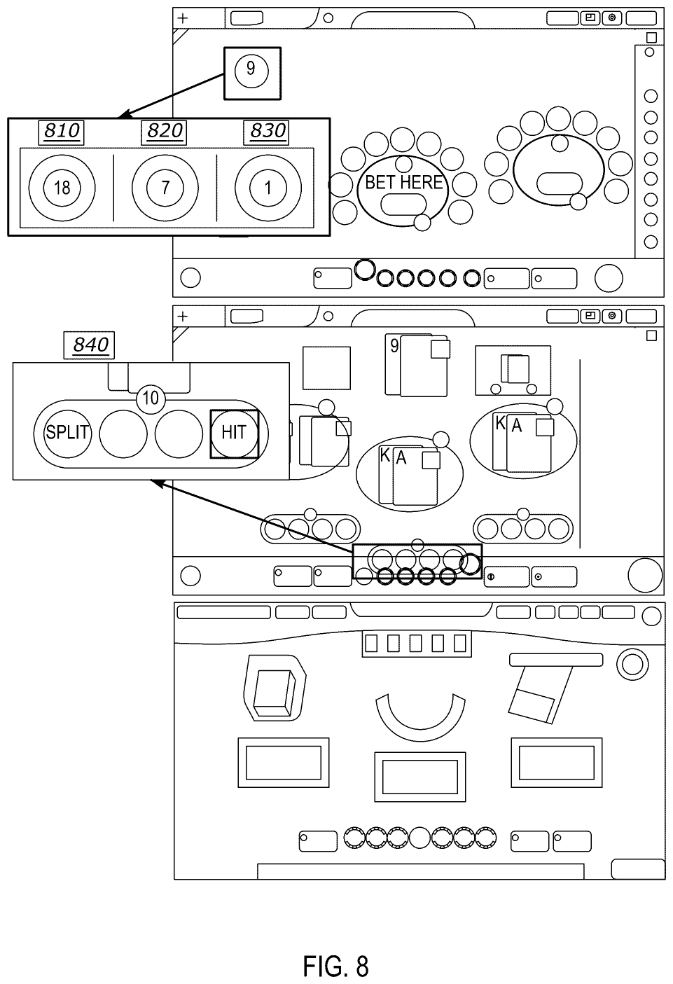

FIG. 8 illustrates additional blackjack betting layout examples and features.

Betting indicators 810, 820, 830 may provide information regarding whether a betting window is open or closed, and to help a player to quickly determine where and when to place bets. A first indicator 810 may be provided in a first color (e.g., green) to indicate that a betting window is open. The indicator 810 may also provide text (e.g., “Place Your Bets”) and a time left in the open betting window. A second indicator 820 may be provided in a second color (e.g., yellow) to indicate that a betting window is closing soon. The indicator 820 may also provide text (e.g., “Last Bets Please”) and the time left in the open betting window. A third indicator 830 may be provided in a third color (e.g., red) to indicate that betting window has minimal time left and/or that a betting window is closed. The indicator 830 may also provide text (e.g., “Last Bets Please” or “No More Bets”), any time left in the betting window, or a time until a new betting window is opened. A Win Amount (e.g., $10.00) may be displayed on the interface following a gaming event. The Win Amount may be displayed using one or more colors and animations on the display.

A set of buttons 840 on the player interface may provide options for a player to take an action with respect to the gaming event. In a blackjack gaming example, the action may be to split, double down, stand, or hit. The set of buttons 840 may be provided for each active hand being played and may provide a countdown or other indicator representing how much time is left in a betting window for a user to take action.

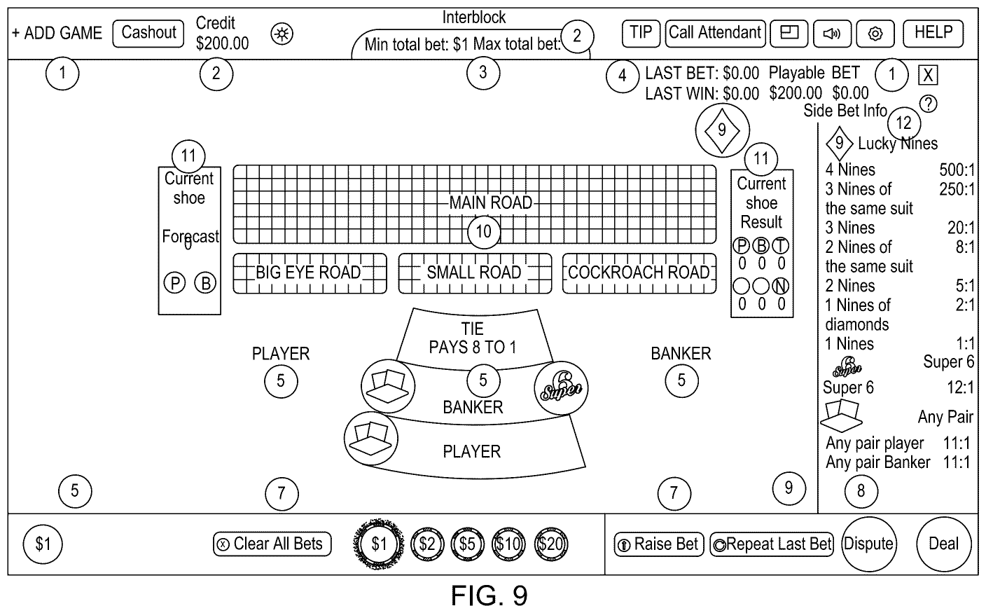

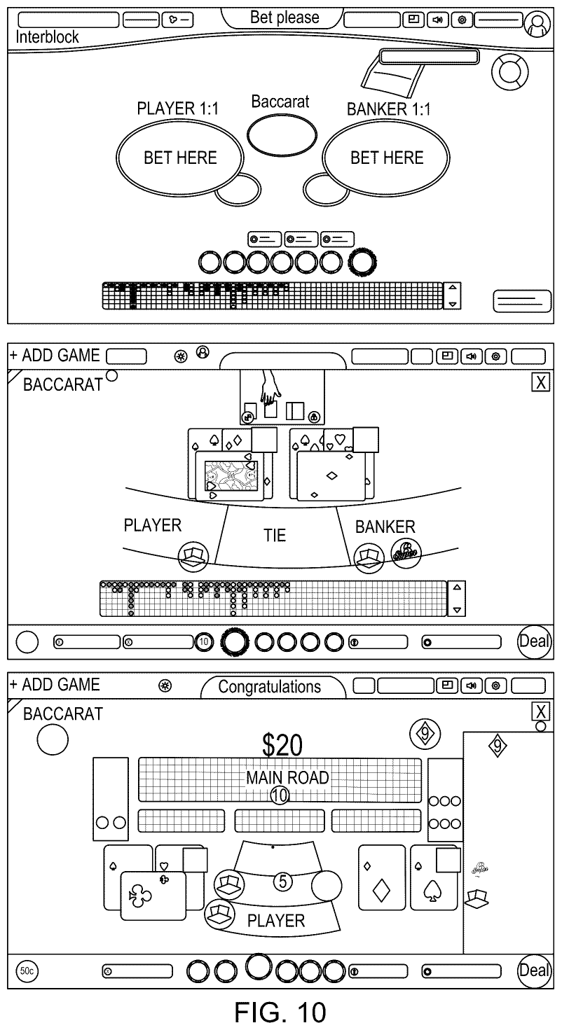

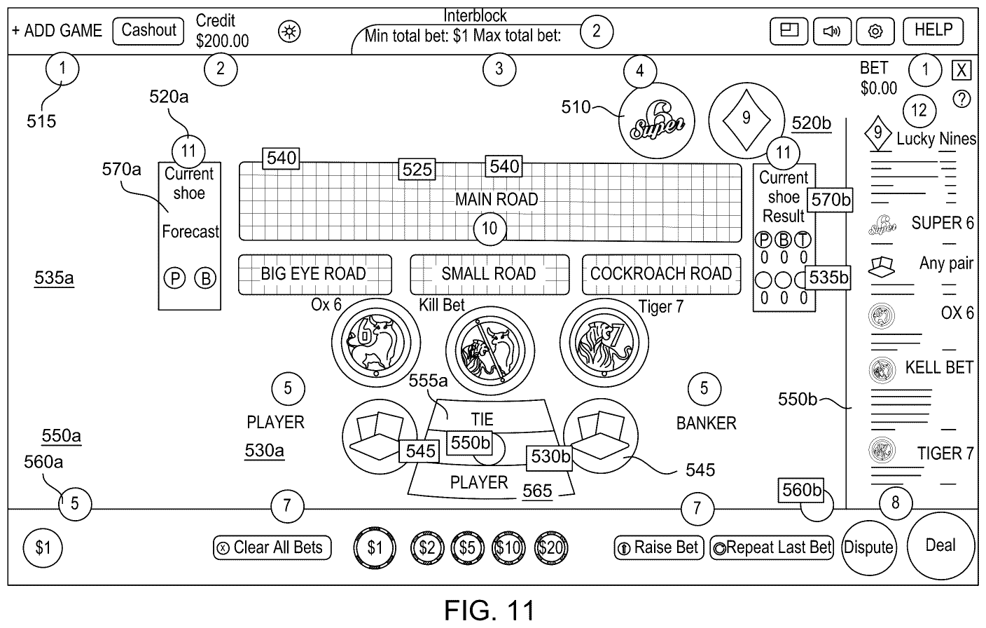

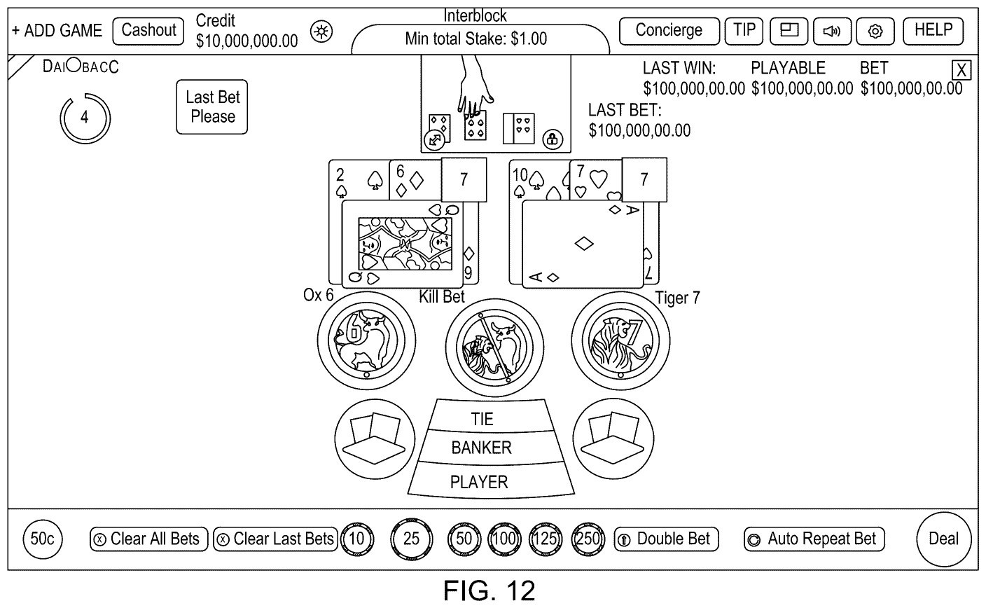

FIGS. 9-12 illustrate example player interfaces for a baccarat or Dai Bacc game played the card gaming tables. The player interfaces may include similar gaming control buttons described with respect to FIGS. 7-8 and provide interfaces for single player and multiplayer options. For example, the interfaces may provide options to add games (e.g., up to four games), close games, and change the way the games are displayed. The player interface may provide gaming and interface controls, such as cashout, credit meter, credit opacity, call concierge/attendant, flags, sounds, options, show winnings, bet values, and help.

Baccarat betting fields enable a player to place bets on Banker, Player, Tie, and Side Bets. Cards will be dealt on the sides of the betting fields. Betting options may include Clear Last Bet/Clear All Bets, Double Bet/Raise Bet, Repeat Last Bet. A Deal Button and Dispute Button may also be provided. Optional buttons include Baccarat trends to show tracked results of the game and possible patterns, and a side bet info button, which shows which side bet payouts have occurred. A Game Information field may display a current shoe (e.g., a current shoe number), a forecast showing which entries will be made in each trend in case of a player or banker win, and a current shoe result showing previous hand results divided into player and banker wins, ties, and naturals, along with the number of player and banker pairs that occurred.

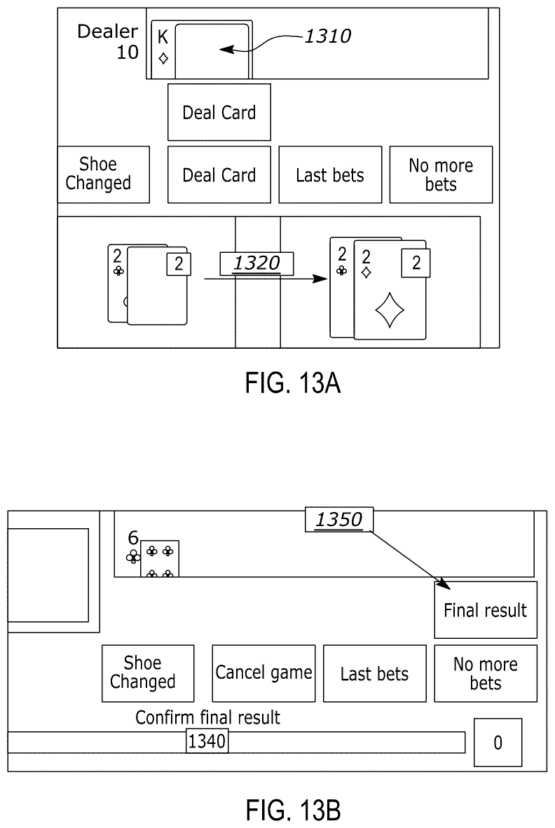

FIG. 13A-B illustrate dealer display interfaces. In examples, the dealer display is provided on a display provided at the card gaming table. Dealer displays may be connected to the card shoe, the dealer console, and/or a separate computing device, which runs an independent dealer interface. The computing devices may communicate information regarding dealt hands and gaming events occurring at the card gaming table.

FIG. 13A illustrates a first dealer interface occurring when a dealer is running a card game. Dealer options A dealer number associated with a dealer identification may be provided on the interface. A dealer hand 1310 area indicates a dealer hand for a game, and a card selection, such as “Deal Card” will cause a new card to be dealt and updated at the dealer hand 1310 area. In some examples, “Deal Card” may cause a card shoe to deal a card, and a card reader located at or near the card shoe may communicate the card value to the dealer console and reflected on the dealer interface. In some examples, the dealer must select the face down card to deal a new card for a player 1320. This selection will also deal a card and update the card at the player interface. Other dealer options at the interface include selections for “Shoe Changed,” “Cancel Game,” “Last Bets,” and “No More Bets.”

When a round ends, a “Final Result” selection 1350 may be required to confirm results and/or initiate payouts. Dealer Instructions 1340 may be provided at the bottom of the dealer interface, as needed, to keep the game progressing. For example, a message area 1340 positioned at the bottom of the dealer interface may indicate instructions and/or a next step required before a next game may proceed.

In the Results area, a temporary result may automatically populate when a hand is dealt and/or when a gaming event is finished. The temporary result may be determined at the dealer console, using one or more sensors associated, e.g., with the card shoe. A dealer must confirm the result prior to a next gaming event begins. The dealer confirmation helps safeguard against errors, such as mechanical and/or detection errors, which might provide a mistaken result.

In an example Blackjack gameplay flow, a player may join a live card table game by logging in to a player account and/or adding credits to a player station. Credits will be displayed on the player interface. The player may bet on the gaming area that currently has open bets. Only one card gaming area will have an open betting window at a time. At the dealer interface, a dealer may select a button (e.g., “Last Bets”) to inform players that the open betting window will close soon. The dealer may select a button (e.g., “No More Bets”) to close the betting window. In some examples, the betting window closes automatically, after a given time has expired. In other examples, the betting window closes automatically when a card or hand is dealt, such as when the dealer selects a deal command at the dealer interface, or when the dealer pulls a first card out of the card shoe.

In a Blackjack or Blackjack Xtreme game, a pair of cards are interchangeably dealt to the player's hand and to the dealer's hand. A player then selects a gaming action (e.g., split, double down, stand, and hit) on the gaming interface. The gaming action will have a limited time (e.g., 10, 15, 20 seconds, etc.) to make a decision. After the player makes a decision or the decision timer runs out, additional player cards are dealt. The decision process repeats until the player decides to stand or their hand busts. In gaming events, such as during Blackjack Xtreme, where more than one hand may require a decision during a gaming event, the player repeats the decision process for each hand separately.

The dealer then flips the card facing down on the table. In some examples, this may also require a selection on the dealer interface to flip the card. The dealer interface selection will turn the card displayed on the player interfaces. The dealer will then draw new cards until a value (e.g., 17 or higher) is reached, or until a bust. The dealer then taps “Final Result” on the dealer interface, and results are announced on player interfaces.

In an example Baccarat or Dai Bacc gameplay flow, players may join a live card table game via a player station, similar to the process described in the Blackjack gameplay flow. A player places a bet, via the player interface, on a regular betting field (e.g., Banker, Player, Tie), and/or on a Side Bets betting field. A selection at the dealer interface may inform players about a time left in the betting window.

The dealer deals cards from the shoe and places them on respective playing fields on the card gaming table. The dealt cards are displayed on the player interface in real-time. Once the dealer deals the required number of cards to each betting position, the results are declared and displayed on the player interface. A player win may initiate a winning animation on the player interface.

FIG. 14 provides an illustration of the live, hybrid ETG card game 1400 with dealer assist. The hybrid ETG card game 1400 includes a card gaming table with two gaming areas 1410, a card shoe, a display 1430 for displaying the results for both card gaming areas 1410, a single dealer with a dealer console 1440, and a plurality of player consoles 1450. The display 1430 is divided between the two card gaming areas 810, one side one color and one side a different color so players can readily tell them apart. Gaming events at each card gaming area 1410 may be controlled by the dealer console 1440. The dual card gaming areas 1410, combined with the player consoles 1450 automatically settling bets in place of the dealer, results in three to four times more game results per hour with virtually zero payout errors. The fact that one dealer can deal more live card to any number of players greatly increases revenue, while the increase in player to dealer ratio, eliminating 1-2 full-time equivalent (FTE) employees, and reducing the compensation cost associated with only needing less skilled dealers, greatly enhances profitability.

In an example, a live ETG baccarat game can be played using the hybrid ETG card game 1400. The baccarat game may include two card shoes for two different hands of baccarat, a display for displaying the results for both card shoes, a single dealer with a dealer console, and a plurality of player consoles. The single dealer can deal the two shoes sequentially, resulting in more hands and more income per hour. The shoes may be shuffled by the dealer, an auto shuffler, or be served by a random generator shoe. The baccarat game options include traditional 5% commission, or no-commission baccarat with a variety of side bets through the graphical user interface of the player consoles, such as lucky nines, any pair, Hi-Ti and super 6. The dual shoes, combined with the player consoles automatically settling bets in place of the dealer, results in more game results per hour with virtually zero payout errors. The fact that one dealer can deal up to two times more live baccarat to any number of players greatly increases revenue, while the increase in player to dealer ratio, eliminating 1-2 full-time equivalent (FTE) employees, and reducing the compensation cost associated with only needing less skilled dealers, greatly enhances profitability.

FIG. 15 illustrates an example arrangement of the ETG card game within a stadium environment, which may include a live arena, or casino pit. In various examples, over 200 stations can be connected to the card game. In some examples, as illustrated in FIG. 15, the player stations may be arranged around the card gaming table in an arena or stadium on a casino floor. In various embodiments, the one or more player stations are arranged in one or more rows 1510, 1520 extending outwardly from the card gaming table. Player stations may be grouped together (e.g., two, three, or more) to allow groups of players to play near each other. Individual player stations may also be provided for solo play within the stadium environment. The one or more player stations may be positioned to face the card gaming table, so as to allow viewing of a display, the dealer, and/or the physical cards at the card gaming table. The card gaming table may be on a raised platform, or otherwise have its height position adjusted to accommodate the particular characteristics of the room. Some stadium arrangements, for example, may include a pit area. The pit area may slope downwards towards the card gaming table, such that the one or more player stations are at a higher height than the card gaming table and can better view the physical cards.

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

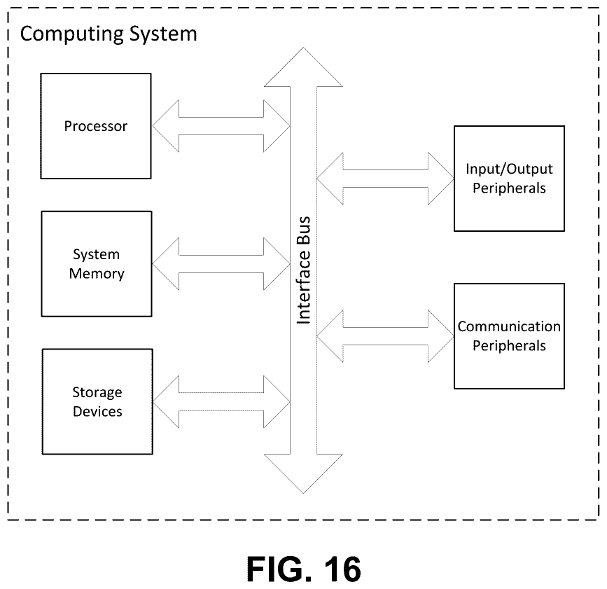

The techniques described above can be implemented on a computing device associated with a gaming device (e.g., a card machine operating a live card game), a plurality of computing devices associated with a plurality of gaming devices, a controller in communication with the gaming device(s) (e.g., a controller configured to synchronize the gaming devices(s)), or a plurality of controllers in communication with the gaming device(s). Additionally, the techniques may be distributed between the computing device(s) and the controller(s). FIG. 16 illustrates an exemplary block diagram of a computing system that includes hardware modules, software module, and a combination thereof and that can be implemented as the computing device and/or as the server.

In a basic configuration, the computing system may include at least a processor, a system memory, a storage device, input/output peripherals, communication peripherals, and an interface bus. Instructions stored in the memory may be executed by the processor to perform a variety of methods and operations, including card shoe operations, adjustments and result detection optimization, as described above. The computing system components may be present in the gaming device, in a server or other component of a network, or distributed between some combinations of such devices.

The interface bus is configured to communicate, transmit, and transfer data, controls, and commands between the various components of the electronic device. The system memory and the storage device comprise computer readable storage media, such as RAM, ROM, EEPROM, hard-drives, CD-ROMs, optical storage devices, magnetic storage devices, flash memory, and other tangible storage media. Any of such computer readable storage medium can be configured to store instructions or program codes embodying aspects of the disclosure. Additionally, the system memory comprises an operation system and applications. The processor is configured to execute the stored instructions and can comprise, for example, a logical processing unit, a microprocessor, a digital signal processor, and the like.

The system memory and the storage device may also comprise computer readable signal media. A computer readable signal medium may include a propagated data signal with computer readable program code embodied therein. Such a propagated signal may take any of variety of forms including, but not limited to, electro-magnetic, optical, or any combination thereof. A computer readable signal medium may be any computer readable medium that is not a computer readable storage medium and that can communicate, propagate, or transport a program for use in connection with the computing system.

Further, the input and output peripherals include user interfaces such as a keyboard, screen, microphone, speaker, other input/output devices, and computing components such as digital-to-analog and analog-to-digital converters, graphical processing units, serial ports, parallel ports, and universal serial bus. The input/output peripherals may also include a variety of sensors, such as light, proximity, GPS, magnetic field, altitude, and velocity/acceleration. RSSI, and distance sensors, as well as other types of sensors. The input/output peripherals may be connected to the processor through any of the ports coupled to the interface bus.

The user interfaces can be configured to allow a user of the computing system to interact with the computing system. For example, the computing system may include instructions that, when executed, cause the computing system to generate a user interface and carry out other methods and operations that the user can use to provide input to the computing system and to receive an output from the computing system.

This user interface may be in the form of a graphical user interface that is rendered at the screen and that is coupled with audio transmitted on the speaker and microphone and input received at the keyboard. In an embodiment, the user interface can be locally generated at the computing system. In another embodiment, the user interface may be hosted on a remote computing system and rendered at the computing system. For example, the server may generate the user interface and may transmit information related thereto to the computing device that, in turn, renders the user interface to the user. The computing device may, for example, execute a browser or an application that exposes an application program interface (API) at the server to access the user interface hosted on the server.

Finally, the communication peripherals of the computing system are configured to facilitate communication between the computing system and other computing systems (e.g., between the computing device and the server) over a communications network. The communication peripherals include, for example, a network interface controller, modem, various modulators/demodulators and encoders/decoders, wireless and wired interface cards, antenna, and the like.

The communication network includes a network of any type that is suitable for providing communications between the computing device and the server and may comprise a combination of discrete networks which may use different technologies. For example, the communications network includes a cellular network, a Wi-Fi/broadband network, a local area network (LAN), a wide area network (WAN), a telephony network, a fiber-optic network, or combinations thereof. In an example embodiment, the communication network includes the Internet and any networks adapted to communicate with the Internet. The communications network may be also configured as a means for transmitting data between the computing device and the server.

The techniques described above may be embodied in, and fully or partially automated by, code modules executed by one or more computers or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile, or non-volatile storage.

In an embodiment, a card gaming system, comprising: a card table comprising a playing surface defining at least one gaming area; at least one camera capturing a live feed of the at least one gaming area; a dealer console provided at the card table, the dealer console comprising an interactive user interface to enable a dealer to manage aspects of gaming events at the card table, wherein the dealer console opens a betting window for a first gaming event, and closes the betting window in response to at least one of: a selection at the interactive dealer interface and a time expiration of the betting window; and a gaming interface provided at a player display, wherein the gaming interface provides the live feed of the at least one gaming area, and the gaming interface is configured to, in response to a selection made at the gaming interface, place a bet for the first gaming event during the betting window set at the dealer console.

In an embodiment, wherein the dealer console provides at least one selection, at the gaming interface, for at least one of: a time left to accept bets, no more bets, and gaming event results.

In an embodiment, wherein the gaming interface displays a result of the first gaming event, in real-time.

In an embodiment, further comprising: one or more player stations arranged around the card gaming table, wherein each of the player stations comprise a display providing the gaming interface.

In an embodiment, wherein the one or more player stations are located in an arena on a casino floor, wherein the arena comprises an interior area and a perimeter, and the one or more player stations face the card gaming table.

In an embodiment, wherein the one or more player stations are arranged in a stadium configuration, wherein the stadium configuration comprises a plurality of rows extending outwardly from the card gaming table, and wherein the one or more player stations face the card gaming table.

In an embodiment, wherein the gaming interface comprises a betting layout comprising a plurality of areas representing individual games playable against a dealer hand.

In an embodiment, further comprising: a card shoe in communication with the dealer console, wherein a card drawn from the card shoe is displayed on at least one of the interactive user interface and the gaming interface.

In an embodiment, wherein the interactive dealer interface is configured to automatically resolve the bet for the first gaming event after the result of the first gaming event is confirmed.

In an embodiment, a card table for hybrid gaming, comprising: a first card gaming area and a second card gaming area provided on a top surface of a standalone gaming cabinet; at least one camera capturing a live feed of the first card gaming area and the second card gaming area; at least one display to be directed toward a dealer operating the card table, wherein the at least one display comprises the live feed of the first card gaming area and the second card gaming area; and an interactive dealer interface provided on the at least one display to enable the dealer to operate gaming events at the first card gaming area and the second card gaming area.

In an embodiment, wherein the standalone gaming cabinet comprises an interior portion for housing electronic components.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

The terms and descriptions used above are set forth by way of illustration only and are not meant as limitations. Those skilled in the art will recognize that those and many other variations, enhancements and modifications of the concepts described herein are possible without departing from the underlying principles of the invention. The scope of the invention should therefore be determined only by the following claims and their equivalents.

What is claimed is:

1. A card gaming system, comprising:
a card table comprising a playing surface defining at least one gaming area;
at least one camera capturing a live feed of the at least one gaming area;
a dealer console provided at the card table, the dealer console comprising an interactive user interface to enable a dealer to manage aspects of gaming events at the card table, wherein the dealer console opens a betting window for a first gaming event, and closes the betting window in response to at least one of: a selection at the interactive dealer interface and a time expiration of the betting window; and
a gaming interface provided at a player display, wherein the gaming interface provides the live feed of the at least one gaming area, and the gaming interface is configured to, in response to a selection made at the gaming interface, place a bet for the first gaming event during the betting window set at the dealer console.

2. The card gaming system of claim 1, wherein the dealer console provides at least one selection, at the gaming interface, for at least one of: a time left to accept bets, no more bets, and gaming event results.

3. The card gaming system of claim 1, wherein the gaming interface displays a result of the first gaming event, in real-time.

4. The card gaming system of claim 1, further comprising: one or more player stations arranged around the card gaming table, wherein each of the player stations comprise a display providing the gaming interface.

5. The card gaming system of claim 4, wherein the one or more player stations are located in an arena on a casino floor, wherein the arena comprises an interior area and a perimeter, and the one or more player stations face the card gaming table.

6. The card gaming system of claim 4, wherein the one or more player stations are arranged in a stadium configuration, wherein the stadium configuration comprises a plurality of rows extending outwardly from the card gaming table, and wherein the one or more player stations face the card gaming table.

7. The card gaming system of claim 1, wherein the gaming interface comprises a betting layout comprising a plurality of areas representing individual games playable against a dealer hand.

8. The card gaming system of claim 1, further comprising: a card shoe in communication with the dealer console, wherein a card drawn from the card shoe is displayed on at least one of the interactive user interface and the gaming interface.

9. The card gaming system of claim 1, wherein the interactive dealer interface is configured to automatically resolve the bet for the first gaming event after the result of the first gaming event is confirmed.

10. A card table for hybrid gaming, comprising:
a first card gaming area and a second card gaming area provided on a top surface of a standalone gaming cabinet;
at least one camera capturing a live feed of the first card gaming area and the second card gaming area;
at least one display to be directed toward a dealer operating the card table, wherein the at least one display comprises the live feed of the first card gaming area and the second card gaming area; and
an interactive dealer interface provided on the at least one display to enable the dealer to operate gaming events at the first card gaming area and the second card gaming area.

11. The card table of claim 10, wherein the standalone gaming cabinet comprises an interior portion for housing electronic components.
